(19) United States
(12) Patent Application Publication
(10) Pub. No.: US 2007/0227418 A1
(43) Pub. Date: Oct. 4, 2007

(54) Apparatus for eliminating undesirable vegetation

(76) Inventor: Jeffrey J. Polfer, Postville, IA (US)

Correspondence Address: JAMES RAY & ASSOCIATES, 2640 PITCAIRN ROAD, MONROEVILLE, PA, 15146, US

(21) Appl. No.: 11/731,374

(22) Filed: Mar. 30, 2007

Related U.S. Application Data
(60) Provisional application No. 60/787,352, filed on Mar. 30, 2006.

(51) Int. Cl. A01C 23/00

(52) U.S. Cl. 111/127

(57) ABSTRACT

An apparatus for eliminating undesirable vegetation in agricultural crop cultivation environment includes a rigid frame and a plurality of nozzles secured to the frame for applying liquid. A power source is mounted on the rigid frame and is connected to the power source of a vehicle employed in the agricultural crop cultivation environment and employed for moving the apparatus. A motor operable pump is connected to a source of the liquid and to the nozzles for delivering the liquid under pressure and a steam generator is provided for heating the liquid. Optional coulters and sweeps are also provided for destroying the root portion of the undesirable vegetation.

### CROSS-REFERENCE TO RELATED APPLICATIONS

This application is related to and claims priority from Provisional Patent Application Ser. No. 60/787,352 filed Mar. 30, 2006.

### FIELD OF THE INVENTION

The present invention relates, in general, to an apparatus for controlling or eliminating vegetation and, more particularly, this invention relates to an apparatus for controlling or eliminating undesirable vegetation in agricultural crop cultivation environment utilizing steam, heated water or heated manure.

### BACKGROUND OF THE INVENTION

As is generally well known, farmers using conventional crop production practices apply high amounts of costly chemicals to control vegetative pests. The high amounts of these harsh chemicals are detrimental to the environment as well as to the human population. The soil and nearby water systems become tainted with these contaminates and remain tainted for extending periods of time even years. Additionally, chemicals, often refer to as herbicides, are deposited on the crop itself posing health risks to consumers. That is why organic farming has been lately gaining wide acceptance with both farmers and consumers. However, farmers using organic crop production methods cannot use harsh chemicals to control vegetative pests and often lose 40 to 60% of their crop due to uncontrollable grasses and weeds that choke and overpower the crop growth.

Prior to the present invention efforts have been made to use steam or heated water to control undesirable vegetation growth. U.S. Pat. No. 6,047,900 issued to Newson et al., U.S. Pat. No. 5,848,492 issued to Brown, U.S. Pat. Nos. 5,430,970, 5,366,154 and 5,297,730 all issued to Thompson et al., U.S. Pat. No. 5,020,510 issued to Jones, U.S. Pat. No. 1,487,367 and U.S. Pat. No. 1,238,861 both issued to Williams et al. and U.S. Pat. No. 1,195,027 issued to Jones provide various systems for heating water, delivering steam or heated water under pressure to a plurality of nozzles and using the nozzles to apply steam or heated water to the undesirable vegetation. However, the prior art systems are either used in combination with the locomotive or include independent internal combustion engine. The use of fossil fuel burning engines generates undesirable emission gasses. Furthermore, it has been determined that it is desirable to improve presently employed methods of using steam or heated water to exterminate undesirable vegetation.

### SUMMARY OF THE INVENTION

According to one embodiment, the invention provides an apparatus for at least one of controlling and eliminating undesirable vegetation in agricultural crop cultivation environment. The apparatus includes a rigid frame which has a front end and an opposed rear end. A plurality of nozzles secured to the frame for applying a preselected liquid to the undesirable vegetation. The nozzles are spaced in relationship to each other. A power source is also mounted on the rigid frame. Means is mounted on the rigid frame and coupled to the power source and to a storage source of the preselected liquid for delivering the preselected liquid under pressure to at least one of the plurality of nozzles causing the preselected liquid to be applied onto the undesirable vegetation. There is means which is mounted on the rigid frame and coupled to the liquid delivering means and to the power source for heating the preselected liquid. The apparatus additionally includes a connecting means for connecting the power source to a power take off unit of a vehicle employed in the agricultural crop cultivation environment and employed for moving the apparatus.

According to another embodiment, the invention provides an improved vehicle for employment in agricultural crop cultivation environment characterized by presence of undesirable vegetation. Such improved vehicle includes means which is directly attached to the vehicle for applying a preselected liquid to the undesirable vegetation. There is also means which is directly attached to the vehicle and connected to a source of the preselected liquid and to the liquid applying means for delivering the preselected liquid to the liquid applying means at each of a predetermined temperature and a predetermined pressure, the liquid delivering means is connected to and operable by a power source of the vehicle.

### OBJECTS OF THE INVENTION

It is, therefore, one of the primary objects of the present invention to provide an apparatus for eliminating undesirable vegetation in agricultural crop cultivation environment.

Another object of the present invention is to provide an apparatus for eliminating undesirable vegetation in agricultural crop cultivation environment which employs steam, heated water or heated manure.

Yet another object of the present invention is to provide an apparatus for eliminating undesirable vegetation in agricultural crop cultivation environment which does not require use of additional internal combustion engine.

A further object of the present invention is to provide apparatus for eliminating undesirable vegetation in agricultural crop cultivation environment which provides for monitoring and safety of the application process.

Yet a further object of the present invention is to provide apparatus for eliminating undesirable vegetation in agricultural crop cultivation environment which is connected to the power system of the vehicle generally employed in such crop cultivation environment.

An additional object of the present invention is to provide an apparatus for eliminating undesirable vegetation in agricultural crop cultivation environment which accommodates for varying heights of the cultivated crop and undesirable vegetation.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a perspective view of an apparatus for eliminating undesirable vegetation which is constructed according to a presently preferred embodiment of the invention;

FIG. 2 is a perspective view of the apparatus for eliminating undesirable vegetation constructed according to another embodiment of the invention employed in combination with a vehicle used in agricultural crop cultivation;

FIG. 3 is a side elevation view of the apparatus of FIG. 1;

FIG. 4 is a schematic diagram of the apparatus of FIG. 1;

FIG. 5 is a schematic diagram of a control system capable of controlling operation of the apparatus of FIG. 1; and

FIGS. 6a-6c illustrate various embodiments of attaching liquid tanks used in the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

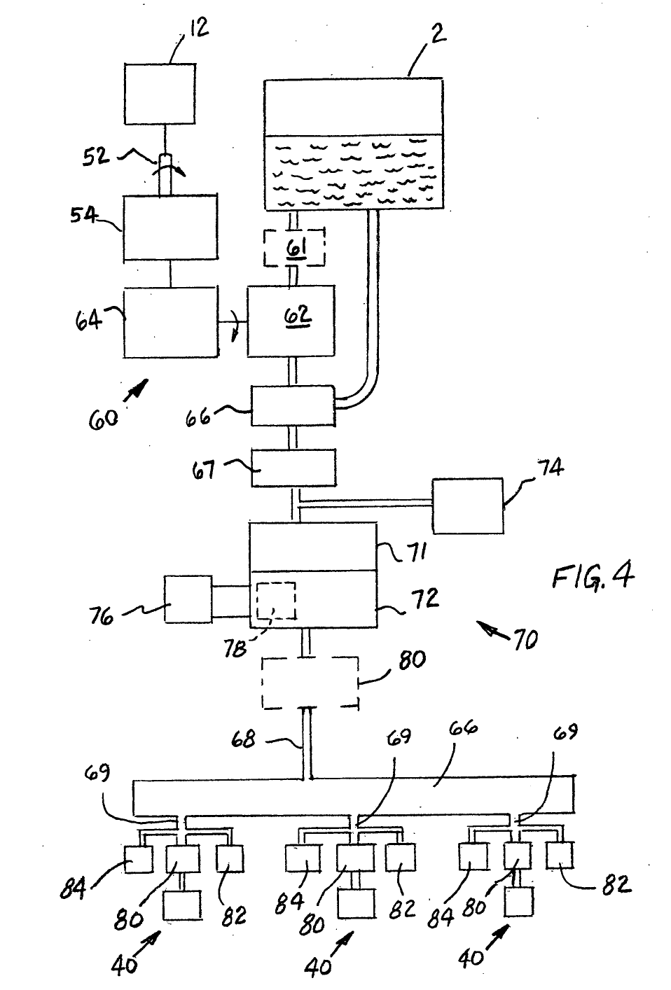

Reference is now made, to FIGS. 1-6c, wherein there is shown an apparatus, generally designated as 20, for at least one of controlling and eliminating undesirable vegetation 6 in agricultural crop cultivation environment. The apparatus 20 includes a rigid frame, generally designated as 30, which has a front end 32 and an opposed rear end 34. Even though, the frame 30 is illustrated in FIG. 1 as being constructed from tubular members joined together in a mechanical fashion, preferably by welding, any other frame types may be employed in the present invention. For example, the frame 30 may be formed from a metal or plastic sheet.

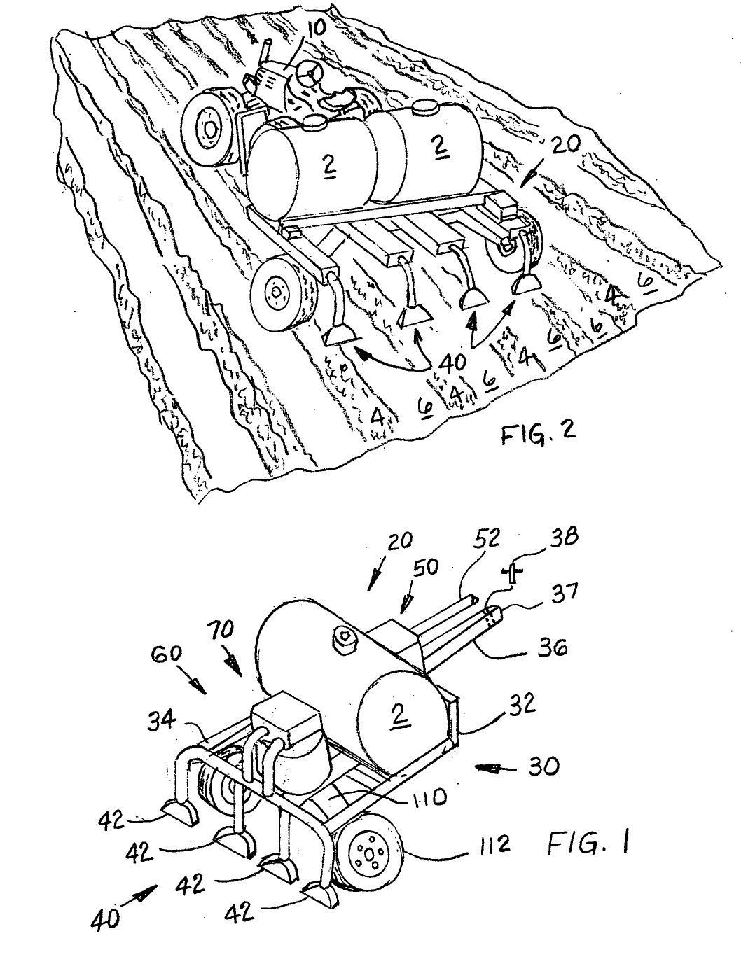

Preferably, the rigid frame 30 further includes a hitch means 36 disposed on and secured to the front end 32 of the rigid frame 30 for a releasable connection to a drawbar 14 of the vehicle 10. The hitch means 36 may be of a well known arrangement which includes eye 37 and pin 38. Accordingly, at least one axle 110 is conventionally secured to the rigid frame 30 between the front end 32 and the rear end 34 thereof. A ground engaging wheel 112 is mounted on each end of the at least one axle 86. It will be appreciated that such rigid frame 30 is being simply towed by a vehicle 10 which is shown in FIG. 2 as a conventional tractor.

The present invention equally contemplates that the front end 32 may be rigidly secured to the vehicle 10 with the rigid frame 30 outwardly extending from the rear end of the vehicle 10 in a cantilevered fashion.

A plurality of nozzle means, generally designated as 40, is secured to the frame 30 for applying a preselected liquid to the undesirable vegetation. The nozzle means 40 are disposed in a spaced relationship to each other. Each nozzle means 40 includes an applicator head 42 and a dispersing nozzle 44 which is mounted within the applicator head 42. The applicator head 42 may be flexibly attached, for example with a semi-rigid hose, and is sized to apply steam directly onto targeted rows of undesirable vegetation 6 bypassing the rows of crop 4 being cultivated. It will be appreciated that applicator heads 42 will be available in various sizes and shapes enabling the operator of the vehicle 10 to adjust the application process in accordance with environmental conditions, crop age and canopy size of the crop.

A power source 50 is mounted on the rigid frame 30.

Means, generally designated as 60, is mounted on the rigid frame 30 and coupled to the power source 50 and to a storage source 2 of the preselected liquid for delivering the preselected liquid, heated and under pressure, to at least one of the plurality of nozzle means 40 thus causing the preselected liquid to be applied onto the undesirable vegetation 6.

There is also means, generally designated as 70, which is mounted on the rigid frame 30 and coupled to the liquid delivery means 60 and to the power source 50 for heating the preselected liquid.

In accordance with one embodiment of the present invention, the apparatus 20 includes a connecting means for connecting the power source 50 to a power source of a vehicle 10 employed in the agricultural crop cultivation environment. It will be appreciated that vehicle 10 generates power in order to enable its movement, therefore connecting the power source 50 to the power source eliminates the need to provide an independent internal combustion engine and further eliminates generation of undesirable emission gasses as relative to prior art systems. According to one embodiment of the invention, the power source of the vehicle 10 is its power takeoff (PTO) shaft 12 and the power source 50 includes a splined coupling 52 for connection to PTO shaft 12. The power source 50 further includes a conventional electrical generator 54 capable of converting mechanical rotation of the PTO shaft 12 into conventional electrical power.

Thus, the liquid delivery means 60 and the liquid heating means 70 are selected to be operable by electrical power characterized by either alternative current or direct current.

According to another embodiment of the invention, the power source of the vehicle is its electrical battery 13 enabling the connection of the liquid delivery means 60 and liquid heating means 70 to such battery 13.

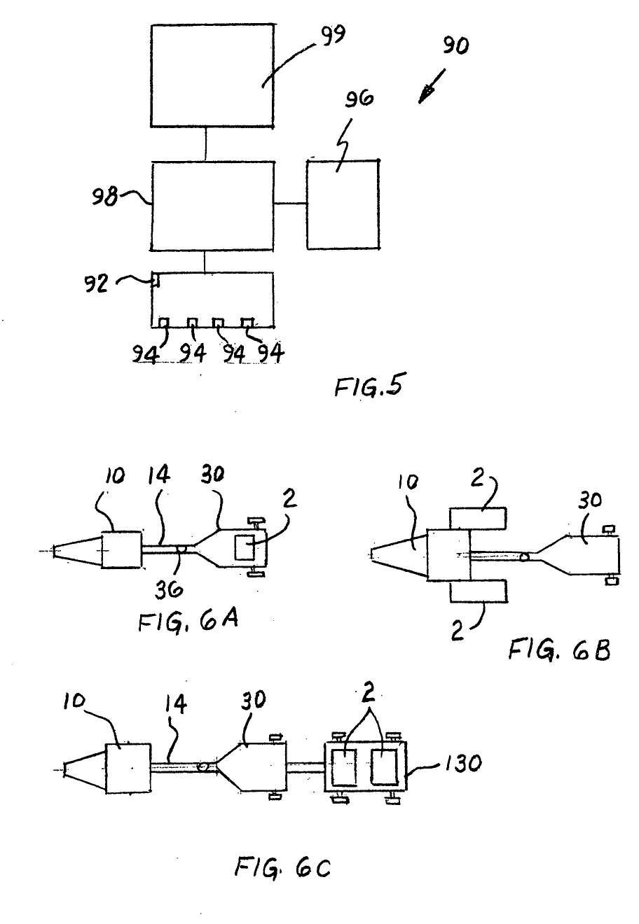

Preferably, the source 2 of the preselected liquid, such as at least one conventional tank is disposed on and secured to the rigid frame 30, as best shown in FIGS. 1-3 and 6a. Alternatively, as shown in FIG. 6b, a pair of tanks 2 may be mounted on each side of the vehicle 10 in what is commonly known as a saddle arrangement. Yet alternatively, as shown in FIG. 6c, the at least one tank 2 may be mounted on a separate frame 130 and releaseably connected to the rear end 34 for towing behind the rigid frame 30.

In the presently preferred embodiment of the invention, the preselected liquid is water. Accordingly the heating means 70 includes at least a heater 71 for heating the water. It is further presently preferred to convert the heated water into steam. Accordingly, the heating means 70 includes a conventional steam generator 72 for converting the water into one of a wet steam and a dry steam. Furthermore, liquid delivery means 60 includes a pump 62, such as DC or AC electric diaphragm pump, driven by a motor 64 in a conventional fashion and a splitter means, such as manifold 66 having an inlet 68 which is connected to the pump 62 and a plurality of outputs 69 each connected to a respective one of the plurality of nozzle means 40. The present invention anticipates the need to control the pressure of the delivered liquid and therefore provides various valves and pressure switches. Although one control valve 80, a pressure switch 82 and a safety valve 84 may be operably connected upstream of the inlet 68, it is presently prefer to mount one control valve 80, a pressure switch 82 and a safety valve 84 after each output 69 and before the nozzle means 40.

In accordance with another embodiment, the present invention provides a controller 90 which is mounted in close proximity to the operator of the vehicle 10 and which enables the operator to closely control and monitor the application process. The controller 90 includes user interface 92, input/output module 96 and processing unit 98. An optional display 99 may be also provided for ease and convenience of operating the apparatus 20 and for monitoring its performance. It will be appreciated that controller 90 provides output signal to the motor 64 and control valve 80 and controls the power used to energize the pump 62 and pressure switches 82. Thus, the pump 62 can be turned on and off by simply activating a switch 92. The same applies for the control valves 80 by using a plurality of control switches 94 which serve the purpose of opening and closing control valves 80. Thus, control valves 80 can be individually controlled by the operator depending on the application requirements.

The pressure switches 82 advantageously serve a secondary function related to safe operation of the apparatus 10.

In an event that a high pressure line connecting control valve 80, pressure switch 82 and nozzle means 40 fail, causing steam to spew, the pressure in that particular line will be lost or will be reduced significantly thus triggering the pressure switch 82. The pressure switch 82 will automatically close the control valve 80 thus shutting down the faulted line and providing for safe repair effort.

It will be appreciated that the controller 90 will annunciate condition of the pressure switches 82 and control valves 80. In the event, the failure, as previously described, should occur without providing visual annunciation to the operator who is generally positioned to face in the opposite direction, the controller 90 would respond to closure of the pressure switch 82 and notify the operator about the problem with specific application line. The operator can then address the problem immediately as opposed to continuing an incomplete application process.

Preferably, the inline pump 62 is located toward the rear of the water tank 2 and will receive intake water through a hose by gravity flow from the tank 2.

It has been found adequate for the pump output flow forced through a low pressure hose to the steam generator 72 to be preferably about 2.75 G.P.M. and the pressure to be between about 30 psi and about 35 psi, although it will be understood that the flow rate and pressure will depend on the specific application requirements and will further depend on quantity of nozzle means 40.

In the event the pump 62 continues to operate while the steam generator 72 or the control valves 80 are not requiring water, a pump bypass valve 66 is provided and will open thus allowing water to return to the tank 2 or to circulate within the pump 62 keeping it from running dry or hot thus protecting the pump 62 from possible damage.

As water motivates through the steam generator 72 it will be preferably converted to wet steam at an approximate ratio of steam to water of about 75% to 25% respectively.

Advantageously a flow meter member 74 is provided and operably coupled to the steam generator 72 for measuring the flow rate through the steam generator 72. When the flow meter 74 detects that the flow rate reaches a predetermined minimum value, it provides a control signal enabling the main output valve 67 to close. Furthermore, when control valves 82 are closed either manually by the operator of the vehicle 10 or by failure in the line, the flow meter 74 will detect such condition due to diminished water flow and will respond to this condition by closing the valve 67 thus discontinuing supply of steam to control valves 82. Thus, the apparatus 10 is afforded with a redundant safety feature. The control circuit is arranged so that when the outlet valve 67 is closed, the steam generator bypass valve 76 opens allowing water to circulate within the steam generator 72 cooling and protecting steam generator inner pump 78 from damages. Furthermore, the inline pump 62 supplying water to the preheater 71 and steam generator 72 also operates in its own bypass mode utilizing the bypass valve 66. When the apparatus 10 operates normally, the wet steam flow exiting through the steam generator outlet is received by the control valves 82 which split the main steam flow into a plurality of branches each supplying a respective nozzle means 40.

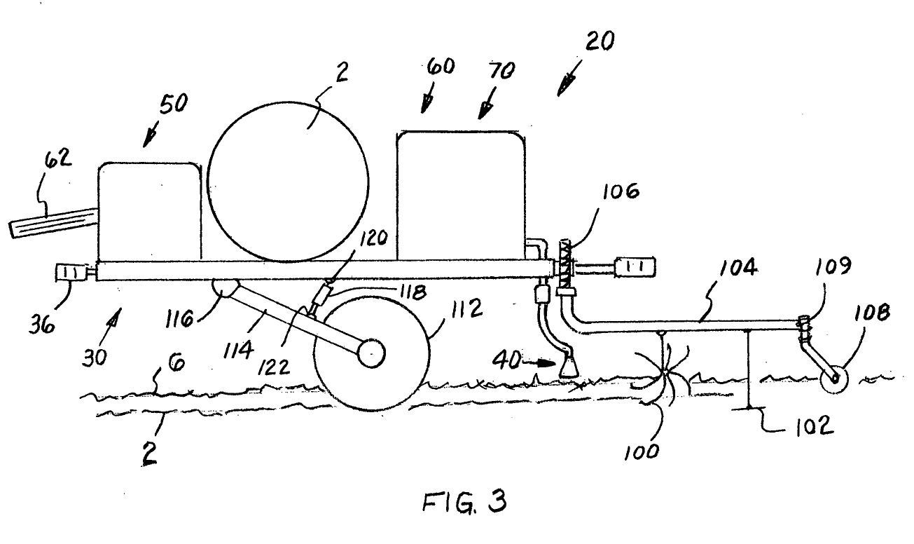

The present invention further contemplates use of optional conventional coulters 100 which cut vertically through the soil and conventional sweeps 102 which are mounted approximately about 12 inches to about 14 inches behind the coulters 100 and which travel under ground. A tandem of coulter 100, which is shown as a wheel but can be also a blade, and sweep 102 is secured to a common mounting member 104. It is contemplated to provide for somewhat flexible mounting member 104 in order to accommodate uneven conditions of the ground soil or mount the mounting member 104 with a spring means 106 as shown in FIG. 3. By way of example in FIG. 3, each nozzle means 40 is mounted approximately about 12 inches to about 14 inches in front of the tandem of coulter 100 and sweep 102 although, the present invention contemplates that the nozzle means 40 may be mounted behind the sweep 102. In issue, coulters 100 and sweeps 102 destroy roots of the undesirable vegetation 6. The nozzle means 40 apply heated water or steam onto foliage of the vegetation 6. Therefore, the method of destroying both the roots and the foliage of the undesirable vegetation 6 increases reliability of the effort to eliminate undesirable vegetation 6 as well as accelerates its decay.

A small wheel 108 biased by a spring 109 is mounted on the very rear of the mounting member 104 for adjusting position of the nozzle means 40 above the ground level 2 and for adjusting the depth of soil penetration by the coulters 100 and sweeps 102.

Alternatively, the apparatus 20 may be provided with means for adjusting the ground engaging wheels 112. In further reference to FIG. 3, such means include one and preferably a pair of rigid members 114 which are pivotally secured to the frame 30 with a pivot means 116 and which is rigidly secured to the wheel 112. A cylinder 118 is pivotally attached to each of the frame 30 at a first pivot means 120 and to the member 114 at a second pivot 122 and operably controlled, preferably by way of the controller 90, for varying the height of the platform 30 above the ground 2 depending on the height of the cultivated crop 4 or the height of the undesirable vegetation 6 to be eliminated. Such adjusting means is taught, for example, in U.S. Pat. No. 5,082,064 issued to Landoll et al. whose teaching is incorporated into this document by reference thereto.

It will be appreciated that the stoke of the cylinder 118 can be selected to lift the nozzles 40, coulters 100 and sweeps 102 above the cultivated crop 4 which is advantageous when the vehicle 10 and the apparatus 20 must be turned around to move in the opposite direction.

The present invention also contemplates the use of liquid manure for eliminating undesirable vegetation and anticipates that an optional filtration means 61 may need to be provided intermediate the pump 62 and the tank 2 which will be capable of holding such liquid manure. It will be appreciated that water is used to remove the manure from animal shelters and stored in the manure pens. The manure contains ammonia as animal by-product that, when heated, was found adequate to eliminate undesirable vegetation 6. Furthermore, manure contains nutrients which are beneficial for soil treatment and therefore, use of liquid manure contains a secondary benefit of improving soil conditions.

Although the present invention has been shown in terms of the apparatus for eliminating undesirable vegetation of the present invention being connected to and operable by a conventional tractor, it will be apparent to those skilled in the art, that the present invention may be applied to other vehicles used in crop cultivation as well as to any vehicle used for control of undesirable vegetation. For example, apparatus 20 may be employed for eliminating weeds growing along the roads and sidewalks.

Furthermore, it will be apparent to those skilled in the art that nozzles 40, power source 50, liquid transfer means 60, liquid heating means 70, coulters 100 and sweeps 102 may be attached directly to various portions of the vehicle 10 to provide for a self-propelled apparatus for controlling or eliminating undesirable vegetation growth, particularly when the liquid tank 2 is also mounted on the vehicle 10.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. An apparatus for at least one of controlling and eliminating undesirable vegetation in agricultural crop cultivation environment, said apparatus comprising:
(a) a rigid frame having a front end and an opposed rear end;
(b) a plurality of nozzle means secured to said frame for applying a preselected liquid to the undesirable vegetation, said plurality of nozzle means disposed in a spaced relationship to each other;
(c) a power source which is mounted on said rigid frame;
(d) means which is mounted on said rigid frame and coupled to said power source and to a storage source of said preselected liquid for delivering said preselected liquid under pressure to at least one of said plurality of nozzle means causing said preselected liquid to be applied onto the undesirable vegetation;
(e) means which is mounted on said rigid frame and coupled to said liquid delivering means and to said power source for heating said preselected liquid; and
(f) a connecting means for connecting said power source to a power take off unit of a vehicle employed in the agricultural crop cultivation environment and employed for moving said apparatus.

2. The apparatus, according to claim 1, wherein said rigid frame includes a hitch means at said front end thereof for releasable connection to a drawbar of the vehicle employed in the agricultural crop cultivation environment.

3. The apparatus, according to claim 2, wherein said hitch means includes an eye and pin arrangement.

4. The apparatus, according to claim 1, wherein said rigid frame includes at least one axle mounted between said front end and said rear end and a wheel mounted on each end of said at least one axle.

5. The apparatus, according to claim 1, wherein said front end is rigidly attached to the vehicle.

6. The apparatus, according to claim 1, wherein said apparatus includes said source of said preselected liquid which is mounted on said rigid frame.

7. The apparatus, according to claim 1, wherein said preselected liquid is water.

8. The apparatus, according to claim 1, wherein said heating means includes a steam generating means for converting said water into one of a wet steam and a dry steam.

9. The apparatus, according to claim 1, wherein said liquid delivery means includes a pump and a splitter means having an inlet which is connected to said pump and a plurality of outputs each connected to a respective one of said plurality of nozzle means.

10. The apparatus, according to claim 9, wherein said liquid delivery means further includes a plurality of safety valves each operably coupled to said respective one of said plurality of nozzle means.

11. The apparatus, according to claim 9, wherein said liquid delivery means further includes a bypass means diverting flow of said preselected liquid from said plurality of nozzle means.

12. The apparatus, according to claim 1, wherein said power source of the vehicle includes a power takeoff unit.

13. The apparatus according to claim 1, wherein said apparatus further includes a plurality of coulters and sweeps operably secured to said frame for destroying the root portion of such undesirable vegetation.

14. The apparatus according to claim 1, wherein said apparatus further includes an adjustment means for adjustably positioning said nozzle means at a predetermined height above the undesirable vegetation.

15. The apparatus according to claim 1, wherein said apparatus further includes a controller for controlling and monitoring operation of at least said liquid heating means and said liquid delivering means.

16. The apparatus according to claim 1, wherein said apparatus further includes means which is responsive to a pressure of said preselected liquid for controlling safety of said apparatus and for annunciating a fault condition.

17. The apparatus according to claim 1, wherein said predetermined liquid include liquid manure.

18. An apparatus for at least one of controlling and eliminating undesirable vegetation in agricultural crop cultivation environment, said apparatus comprising:
(a) means for applying a preselected liquid to the undesirable vegetation;
(b) means connected to a source of said preselected liquid and to said liquid applying means for delivering said preselected liquid to said liquid applying means at each of a predetermined temperature and a predetermined pressure; and
(c) wherein said liquid delivering means is connected to and operable by a power source of a vehicle employed in the agricultural crop cultivation environment and employed for moving said apparatus during application of said preselected liquid.

19. The apparatus, according to claim 16, wherein the power source of the vehicle includes a battery and wherein said liquid delivering means is electrically operable.

20. In a vehicle employed in agricultural crop cultivation environment characterized by presence of undesirable vegetation, an improvement comprising:
(a) means which is directly attached to said vehicle for applying a preselected liquid to the undesirable vegetation; and
(b) means which is directly attached to said vehicle and connected to a source of said preselected liquid and to said liquid applying means for delivering said preselected liquid to said liquid applying means at each of a predetermined temperature and a predetermined pressure, said liquid delivering means is connected to and operable by a power source of said vehicle.
